(19) United States
(12) Patent Application Publication
(10) Pub. No.: US 2011/0314052 A1
(43) Pub. Date: Dec. 22, 2011

(54) ENHANCED SEARCH SYSTEM AND METHOD

(75) Inventors: Alex Francis, Petersfield Hampshire (GB); Jonathan Marsh, Putney London (GB)

(73) Assignee: WANT2BTHERE LTD., London (GB)

(21) Appl. No.: 13/129,390

(22) PCT Filed: Nov. 16, 2009
(86) PCT No.: PCT/GB09/51549

§ 371 Date: Aug. 8, 2011

(30) Foreign Application Priority Data
Nov. 14, 2008 (GB) 0820886.0

(51) Int. Cl. G06F 17/30

(52) U.S. Cl. 707/769; 707/E17.014

(57) ABSTRACT

Systems and methods are described to enable enhanced searching of data, particularly for larger volumes of data where the data has a plurality of attributes. Conventional search systems require complex and intelligent search input from a user or require a large amount of processing power and complex database access functionality to process searches based on complex data. The system described uses predefined search criteria, wherein each search criterion is associated with at least one attribute. In one aspect, images are stored together with an association with a search criterion. The images are provided for display to a user and input is received from the user to select at least one image and therefore the search criterion and attribute associated with the image. The items of data are searched to retrieve items having the at least one selected attribute and a first intermediate list of identifiers of the retrieved items is stored. A total number of items identified in the first intermediate list is calculated and a list of attributes associated with the items identified in the first intermediate list is determined. A revised set of search criteria is then provided for display wherein each search criterion has at least one of the attributes. Further input is received to select a second image and hence a second search criterion and attribute. The retrieved items identified in the first intermediate list are searched to retrieve items having the second selected attribute. A second intermediate list of identifiers of the retrieved items is generated and a total number of items identified in the second intermediate list is output for display. Other features and aspects of the system are also described.

The invention relates to the field of searching and, in particular to methods and systems for providing enhanced search functionality for users, particularly in identifying items having multiple attributes.

Searching can be very processor-intensive, particularly if the system has to process a combination of attributes to generate search results. Traditionally, this has been solved by providing very powerful computers, or clusters of processors to generate the search results. However, as searches become more complex, this approach is difficult to scale.

A further problem that arises when searching based on multiple attributes is that all of the data in the database must be accessible for each search. If there are a number of users searching the database at the same time, which is often the case for a web-based system, all of the data needs to be accessible for multiple simultaneous accesses. If this is not possible, this affects the speed at which the system can generate search results.

Despite these problems, users are turning to information networks, such as the internet, to obtain an increasing range and complexity of information. However, existing search interfaces are usually based on inputting a text string and require the user to have a good idea of the results he requires before he enters the search. That is, the user must ask the right question in the right format in order to get the desired search results. If the search involves a number of variables, that is if the items being searched have a large number of attributes, some existing text based searches also require the user to have a sophisticated level of query programming to enter complex text-based search queries.

The specific area of travel planning is one in which the internet has become a valuable resource. There is a large volume of information available on the internet and users can perform basic searches for this information through web interfaces, for example to obtain details or reviews for hotels in a particular resort or city or to research and book flights to a specific location. However, this usually requires users to have a specific idea of where they would like to go.

Users can also review articles containing suggestions of where to travel and what to visit, but researching such articles is time-consuming.

Similar issues arise for other complex subject matter characterised by multiple attributes that a user may which to research, for example cars, jobs, white goods and electronic equipment. Therefore there is a need for enhanced searching tools that are powerful enough to handle complex queries and yet more intuitive to use.

Aspects of the invention are set out in the independent claims and preferred features are set out in the dependent claims. Preferred features of one aspect can be applied to other aspects unless otherwise stated.

In an aspect there is provided a method of searching a plurality of items using at least one of a plurality of search criteria, the method comprising: providing for display to a user a plurality of images, each image associated with at least one search criterion; receiving input from the user to select at least one image from the plurality of images; determining the or each search criterion associated with the or each selected image; searching the plurality of items to retrieve items based on the or each search criterion; storing in memory a first intermediate list of identifiers of the retrieved items; determining a revised set of search criteria based on the items identified in the first intermediate list; and providing for display a revised set of images associated with the revised set of search criteria; receiving further input from the user to select a second image from the revised set of images and determining a second search criterion based on the second image; and searching the retrieved items identified in the first intermediate list based on the second search criterion.

In an embodiment each item has at least one attribute (typically multiple attributes) and each search criterion is associated with at least one attribute. Attributes can enable the items to be treated as structured data and arranged in a database. Where the items relate to offerings of products or services this provides an intuitive and efficient method of searching structured data without a user needing to assemble a complex database query.

In one possibility the plurality of items includes at least 100 items. Preferably each item has at least three attributes. The search criteria can be predefined and it is possible for each search criterion to be associated with at least one attribute. Images provided for display to a user are typically associated with a plurality of search criteria. An embodiment of the method comprises: storing in a database a plurality of images and storing an association between each image and at least one search criterion. In one possibility the method comprises storing in a database a plurality of search criteria and storing an association between each search criterion and at least one of the plurality of attributes. Preferably the method comprises storing in a database the plurality of items and storing an association between each item and each of a plurality of attributes. In one possibility the method includes determining at least one selected attribute associated with the or each search criterion. To provide a simple indication of an intermediate number of results to a user the method can comprise outputting a total number of items identified in the first intermediate list. Preferably the method includes storing in memory a second intermediate list of identifiers of the items retrieved from the first intermediate list. To provide a second intermediate indication of the number of results the method can include outputting a total number of items identified in the second intermediate list. Preferably searching the plurality of items to retrieve items based on the or each search criterion comprises searching the plurality of items to retrieve items having the at least one selected attribute. Preferably determining a revised set of search criteria comprises determining a revised set of search criteria in which each search criterion in the revised set has at least one attribute associated with the items identified in the first intermediate list. Still more preferably determining a second search criterion comprises determining a second search criterion associated with the second image and a second selected attribute associated with the second search criterion. In one possibility searching the retrieved items identified in the first intermediate list based on the second search criterion comprises searching the retrieved items identified in the first intermediate list to retrieve items having the second selected attribute.

According to one aspect, there is provided a method of searching a plurality of at least one hundred items using at least one of a plurality of predefined search criteria, each item having at least three attributes, wherein each search criterion is associated with at least one attribute, the method comprising:

storing in a database a plurality of images and storing an association between each image and at least one search criterion;

storing in a database a plurality of search criteria and storing an association between each search criterion and at least one of the plurality of attributes;

storing in a database the plurality of items and storing an association between each item and each of a plurality of attributes;

providing for display to a user a plurality of images associated with a plurality of search criteria;

receiving input from the user to select at least one image from the plurality of images;

determining the or each search criterion associated with the or each selected image;

determining at least one selected attribute associated with the or each search criterion;

searching the plurality of items to retrieve items having the at least one selected attribute;

storing in memory a first intermediate list of identifiers of the retrieved items;

outputting a total number of items identified in the first intermediate list;

determining a list of attributes associated with the items identified in the first intermediate list;

determining a revised set of search criteria, wherein each search criterion in the revised set has at least one attribute associated with the items identified in the first intermediate list; and

providing for display a revised set of images associated with the revised set of search criteria;

receiving further input from the user to select a second image from the plurality of images and determining a second search criterion associated with the second image and a second selected attribute associated with the second search criterion;

searching the retrieved items identified in the first intermediate list to retrieve items having the second selected attribute;

storing in memory a second intermediate list of identifiers of the retrieved items;

outputting a total number of items identified in the second intermediate list.

This and other aspects advantageously enable the performance of a more efficient and more scalable search of items having multiple attributes, potentially a large number of attributes. Once a search on the whole database for the first identified attribute has been performed, the claimed method uses the processor more efficiently as it only needs to search the items identified in the first intermediate list to determine if they have the second attribute. As the number of attributes increases, rather than making the search more complex, as in a traditional implementation, the method actually reduces the processing required to generate the search results, since the system is effectively searching an ever smaller number of items.

Similar advantages are provided in the area of memory and database access. Although all of the items are made available for the initial search on the first attribute, once the relevant items have been cut down in the intermediate list, searches based on further selected attributes can be applied to only the identified items. Therefore, as the search becomes more complex, the number of items being accessed by the search process reduces. This reduces the complexity of managing access to items in the database, and to common parts of the memory. In turn, this may increase the number of searches that can be run against the database at any particular time.

The searching and generation of intermediate lists can be performed dynamically and the determination of a revised set of search criteria is preferably also dynamic.

Enabling a user to search by selecting images associated with the various search criteria can provide a powerful but intuitive way to build up a complex search query based on a user's preferences. If the initial search criteria are defined broadly, the search can be broad-ranging despite being limited by predefined search criteria. This is particularly useful for searching within a subject-matter area, for example searches relating to travel. The provision of a limited number of predefined search criteria also helps to guide the user in the search. Further, since the search is based on predefined search criteria and a defined (preferably large) number of attributes, this may also increase the speed of generation of search results.

In an embodiment the method comprises determining a further revised set of search criteria based on the items identified in the second intermediate list; and providing for display a revised set of images associated with the further revised set of search criteria.

In a preferred embodiment, the method further comprises receiving further input from the user to select a further image from the revised set of images;

determining the or each search criterion associated with the further image;

determining the or each further attribute associated with the or each search criterion;

accessing the third intermediate list of identifiers and searching the retrieved items to generate and store a further intermediate list of identifiers of items having the or each further attribute; and

outputting a total number of items identified in the further intermediate list.

As noted above, the third intermediate list of identifiers can be stored in memory to enable a user to further refine the search at a later time. Preferably, the third intermediate list is stored together with the selected attributes that formed the list in a profile associated with the user. However, for an unregistered user, the initial search may be stored only for a short time. The selection of the further image in many embodiments is therefore performed as soon as the user has reviewed the total number of search results generated by the initial search. For example, the initial search may result in 1000 search results, so the user may select a further image to further narrow this search.

In one embodiment, the method further comprises calculating the total number of items that would remain if each of the remaining search criteria was selected in conjunction with the first search criterion. That is, at least for the displayed remaining search criteria, the number of items that would remain if the search criterion was applied to the items in the latest intermediate list is calculated. If the number of items remaining is zero, then the second search criterion may be excluded from possible selection by the user, for example by “greying out” the search criterion or by simply not displaying this option to the user. In this way, the system prevents the user from selecting incompatible combinations of criteria or from entering searches that provide no results.

The total number of items remaining if a displayed search criterion was selected is preferably displayed to the user together with the respective search criterion, for example by displaying the number if the user generates a “mouse-over” event for that criterion. This enables a user to see how many results would remain if they selected that criterion before they add that criterion to their search.

Preferably, the method further comprises generating a composite image comprising a plurality of images having attributes corresponding to the attributes selected by the user. That is, not only are images used by the user to input a search query, but an image, or a composite image is also used to illustrate the search results to the user. This can be a powerful way to give the user a quick overall impression of the results of their search, which may be a combination of multiple factors.

The method preferably further includes displaying an image to the user, wherein the image is associated with each of the search criteria (or attributes) selected by the user. The image may be one of several images, so a changing display of a plurality of relevant images may be shown. The images shown should be compatible with or associated with all of the search criteria selected by the user in the present search.

Preferably, providing for display to a user a plurality of images comprises providing no more than 200 images, preferably no more than 100 images. That is, the user is presented with no more than 200, preferably no more than 100 search criteria. As the user performs the search, the presented search criteria change, but are kept to a small number. As described below, the search criteria may be presented in groups and in a hierarchical order.

Preferably, the plurality of items comprises at least 200 items, preferably 500 items, further preferably 1000 items. Potentially, the system may be used to search a larger number of items, for example 10,000-100,000 items.

Preferably, the number of images selected provides at least five selected attributes and the method includes searching the items to retrieve items having the five selected attributes. The images may be selected by the user as part of the initial search definition or may be selected consecutively as the search results are generated and reviewed. As described above, the way that the system operates enables the combination of a large number of attributes, for example at least 10 or even 20 attributes.

In a preferred embodiment, input is received from a user to provide selected attributes until the total number of items identified is less than 100 items, preferably less than 20 items, further preferably around 5 items. Therefore the search continues until the user has a manageable number of specific items or search results to review.

The method preferably further includes providing for display the list of identifiers of retrieved items having the selected attributes, wherein the identifiers preferably include an image associated with the retrieved items. That is, the items identified in the search i.e. the search results are displayed to the user. Preferably this occurs on a separate screen from the search input screen and requires the user to select a “display results” button. The user may be encouraged to reduce the number of results before displaying the results themselves.

Preferably, each item comprises at least three attributes, preferably at least five attributes and further preferably at least ten attributes

Preferably, at least one of the revised set of images corresponds to at least one search criterion in a lower level of a hierarchy of search criteria. Thus, although the search may start quite broadly, the images can be used to guide the user into a more complex and specific search based on their initial selections. As a user selects a first image that represents a broad category of search results, the revised search criteria change to provide more detailed search criteria with associated images that represent narrower options within the broad selected category.

Preferably, the user interface enables the user to select search criteria by dragging & dropping the images associated with those search criteria onto a specified area of the screen. Alternatively, a user may simply click on an image or on a tick box presented with the image.

The method preferably further allows the selection of negative search criteria, to enable the user to exclude all items having the associated attribute from the search. The method preferably also allows the user to assign weightings to particular search criteria to enable the user to specify if a particular search criterion is of great importance.

Preferably, the method is implemented in the processor of a server, wherein the intermediate list of identifiers of the retrieved items is stored in the memory of the server and wherein the images are provided for display and the total number of retrieved items are output via an output interface of the server. An example of a server, or cluster of servers, that may be used to implement the system is described below.

Preferably, the images and total number of retrieved items are displayed at a client terminal, for example a PC, PDA or mobile telephone.

According to a further aspect, there is provided a method of searching a plurality of items using at least one of a plurality of predefined search criteria, each item having at least three attributes, wherein each search criterion is associated with at least one attribute, the method comprising:

storing in a database a plurality of images and storing an association between each image and at least one search criterion;

storing in a database a plurality of search criteria and storing an association between each search criterion and at least one attribute;

storing in a database the plurality of items and storing an association between each item and each of a plurality of attributes;

providing for display a plurality of images to a user;

receiving input from the user to select an image from the plurality of images;

determining the or each search criterion associated with the selected image;

determining the or each attribute associated with the or each search criterion;

searching the plurality of items to retrieve items having the or each determined attribute;

storing in memory an intermediate list of identifiers of the retrieved items;

outputting a total number of retrieved items having the or each attribute associated with the retrieved option;

determining a list of attributes associated with the retrieved items;

determining a revised set of search criteria, wherein each search criterion in the revised set has at least one attribute associated with the retrieved items; and

providing for display a revised set of images associated with the revised set of search criteria.

According to a further aspect, there is provided a method of searching a plurality of at least one hundred items using at least one of a plurality of predefined search criteria, each item having at least three attributes, wherein each search criterion is associated with at least one attribute, the method comprising:

storing the plurality of predefined search criteria for the search in memory;

providing for display to a user a first selected set of the predefined search criteria;

receiving input from the user to select a first search criterion from the selected set of predefined search criteria;

receiving input from a user to select a second search criterion from the selected set of predefined search criteria;

calculating a total number of items having the attribute associated with the first search criterion and the attribute associated with the second search criterion;

outputting the calculated total number of items for display to the user;

calculating the total number of items remaining if each of the remaining search criteria was selected in conjunction with the first search criterion and the second search criterion;

selecting a modified set of predefined search criteria based on the total number of items remaining;

outputting the modified set of predefined search criteria for display to the user.

In this aspect, two search criteria are applied to the items and the system then determines how many items would remain if the user selects as a third option the remaining search criteria. Depending on the number of items remaining for each search criterion, the modified set of search criteria is created and presented to the user for further selections. For example, further search criteria may only be displayed to a user if the number of items that would remain if they were combined with the existing search is greater than a threshold number.

In a highly preferred embodiment, selecting a modified set of predefined search criteria comprises excluding a search criterion from the modified set if the total number of items remaining if the search criterion was selected is zero. Hence the system identifies in advance search criteria that are incompatible with the options that have already been selected and will not let a user create a search that results in no remaining items.

The method may further include outputting the number of remaining items for each of the search criteria in the modified set of predefined search criteria for display to the user in conjunction with the search criterion. This provides an intuitive way to enable a user to see which remaining search criteria would provide a large number of results and which options significantly narrow the remaining items. The items may be displayed together with the remaining search criteria, for example next to the relevant images, or may be displayed only on request by the user, for example if the user causes the mouse to “hover over” a particular search criterion.

Preferably, the method further comprises:

receiving input from a user to select at least one further search criterion from the modified set of search criteria;

calculating a total number of items having the attributes associated with the first and second search criteria and the attribute(s) associated with the at least one further search criterion;

outputting the calculated total number of items for display to the user;

calculating the total number of items remaining if each of the remaining search criteria was selected in conjunction with the first, second and at least one further search criteria;

selecting a modified set of predefined search criteria based on the total number of items remaining;

outputting the modified set of predefined search criteria for display to the user.

Preferably, the method further comprises receiving input from a user to select at least five search criteria from the selected set of predefined search criteria or the modified set of predefined search criteria. Hence the system may handle a large number of combinations of different attributes.

Preferably, the method further comprises providing for display identifiers of a plurality of items, each item having the attributes associated with the selected search criteria. The items represent the results of the search.

Preferably, the method further comprises providing for display to a user an image as an identifier of each search criterion.

In a preferred embodiment, the method is implemented in the processor of a server, or cluster of servers, and the sets of predefined search criteria and the calculated total number of items are displayed at a client terminal.

According to a further aspect, there is provided a method of producing a summary of a search performed by a user, the method comprising:

receiving a plurality of search criteria from a user;

selecting at least one image associated with each search criterion received;

generating a composite image comprising the plurality of images selected;

providing the composite image for display to a user at a user terminal.

The composite image enables the results to be displayed intuitively to a user to enable quick review.

Preferably, the method includes receiving input from a user indicating the importance of at least one search criterion and incorporating an image associated with the search criterion into the composite image at a relative size corresponding to the importance of the search criterion.

Preferably, the composite image comprises a base image and a plurality of secondary images, the secondary images being overlaid over the base image.

The composite image is preferably stored in a profile associated with the user.

The composite image may also be encoded in a web address, for example a URL.

The method preferably further includes providing a link to enable a user to forward the composite image, or a web address encoding the composite image, to a further user. Preferably the link connects to the stored composite image.

In one embodiment, the method further includes displaying the composite image via a third party website.

According to a further aspect, there is provided a method of searching a plurality of items using a plurality of search criteria, each item having at least one attribute, wherein each search criterion is associated with at least one attribute, the method comprising:
storing a profile for a first user, the profile including at least an identifier of the first user;

composing a search query based on input received from the first user, the search query comprising a plurality of search criteria selected by the first user;

generating search results based on the search query;

storing the search query and/or the search results in association with the profile for the first user;

displaying the search results to the second user;

receiving input from the second user to modify the search query;

generating updated search results based on the modified search query;

displaying the updated results to the first user.

This aspect enables a second user (or users), preferably separated geographically and temporally, to contribute and amend a search already performed by the first user.

Preferably, the method further comprises storing a profile for the second user, the profile including at least an identifier of the second user and storing the updated search results and/or the modified search query in association with the profile for the second user.

In one embodiment, the first and the second user are geographically separated.

In one embodiment, the input is received from the second user at a later time than the input received from the first user.

According to a further aspect, there is provided a method of searching a plurality of items according to the method of the first or second aspect wherein the first search criterion is received from a first user and the second search criterion is received from a second user, wherein the first user is geographically remote from the second user.

This aspect enables a plurality of users to contribute to a single search, for example to produce a group search.

Preferably, the method includes parsing the first search criterion and the second search criterion to determine compatibility between the first search criterion and the second search criterion.

In one embodiment, if the first search criterion and the second search criterion are not compatible, the method includes requesting the second user to confirm that the first search criterion should be over-written by the second search criterion.

In one embodiment, combining the first search criterion and the second search criterion comprises applying the first search criterion to the plurality of items to produce first search results and applying the second search criterion to the first search results to produce combined search results.

In an alternative embodiment, combining the first search criterion and the second search criterion comprises combining the search criteria to generate a single search query.

Preferably, the method further comprises receiving input from a third user to select at least a third search criterion and applying the third search criterion to the plurality of items to produce search results combined with the results of the first search criterion and the second search criterion.

Preferably, the method also includes notifying the first user of at least one of the input received from the second user and the combined search results.

According to a further aspect, there is provided a method according to the first or second aspect and further comprising:

providing an interface via a third party website to display the plurality of search criteria via the third party website;

receiving from a user at the third party website a selection of at least one criterion by the user;

displaying to the user via the third party website the first and second intermediate list of identifiers;

displaying to the user via the third party website a graphical representation of the items identified in the second intermediate list.

Preferably, each search criterion has at least one associated image and wherein the graphical representation comprises a composite image comprising a plurality of images associated with the or each selected search criterion.

In some embodiments, the graphical representation may comprise a link to a primary web interface.

Preferably, the primary web interface provides additional search criteria that are not available via the third party website.

Apparatus aspects corresponding to each of the method aspects described above are also provided and the preferred method features may also be implemented in the apparatus. In particular, a server or cluster of servers may be used to implement the methods set out above, or the methods may be implemented in a plurality of processors over a network, for example the internet. Databases are also implemented in the servers or in separate database servers to store the data and images described. User terminals are also provided that enable a user to interface and interact with the described methods and to view the images and results described. The invention also provides computer program, computer program product and computer readable medium aspects corresponding to the method aspects described.

A description of one embodiment of the search system will now be described with reference to the figures in which:

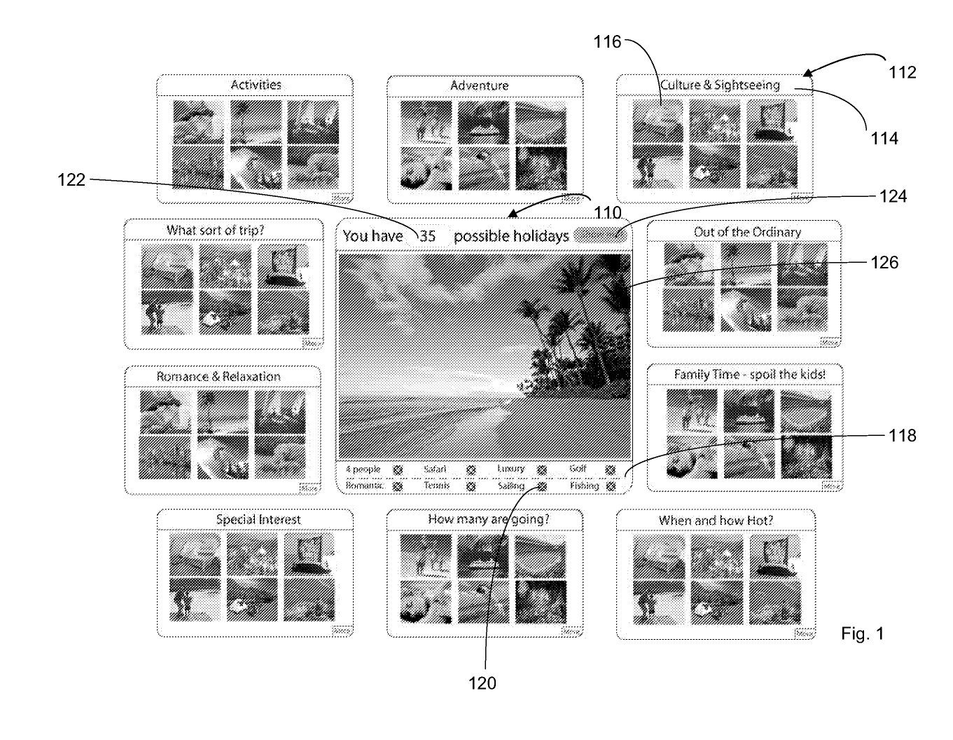

FIG. 1 illustrates one embodiment of a search interface;

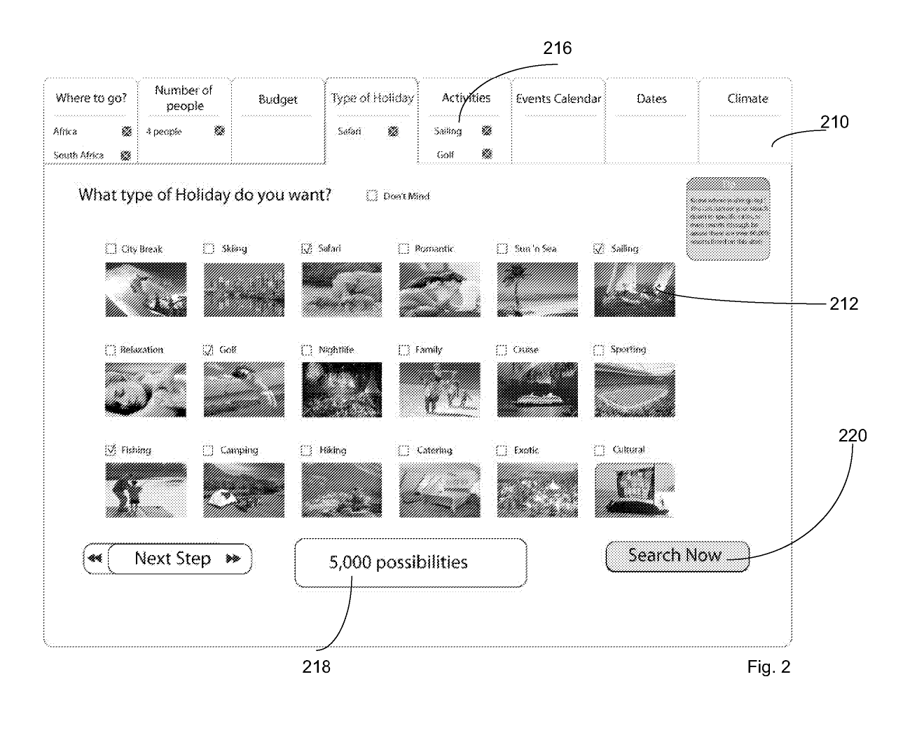

FIG. 2 illustrates a further embodiment of a search interface;

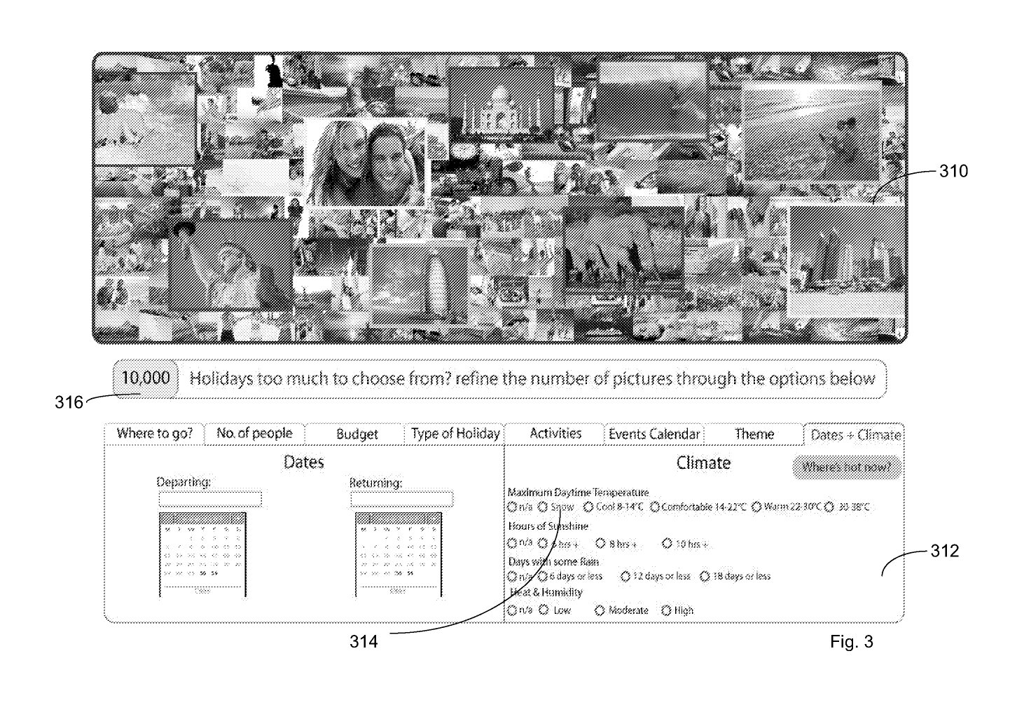

FIG. 3 illustrates a further embodiment of a search interface;

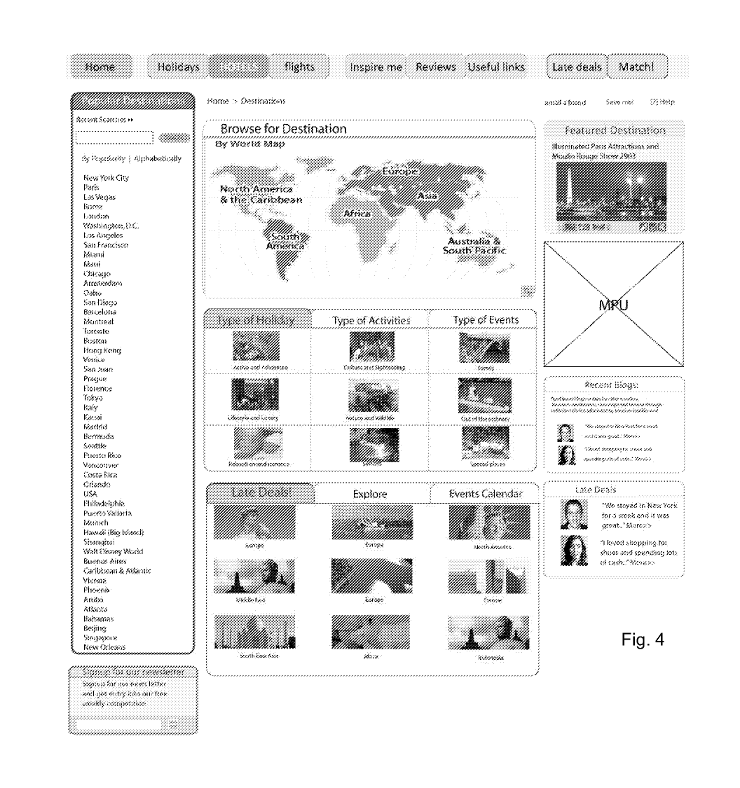

FIG. 4 illustrates an embodiment of an information interface;

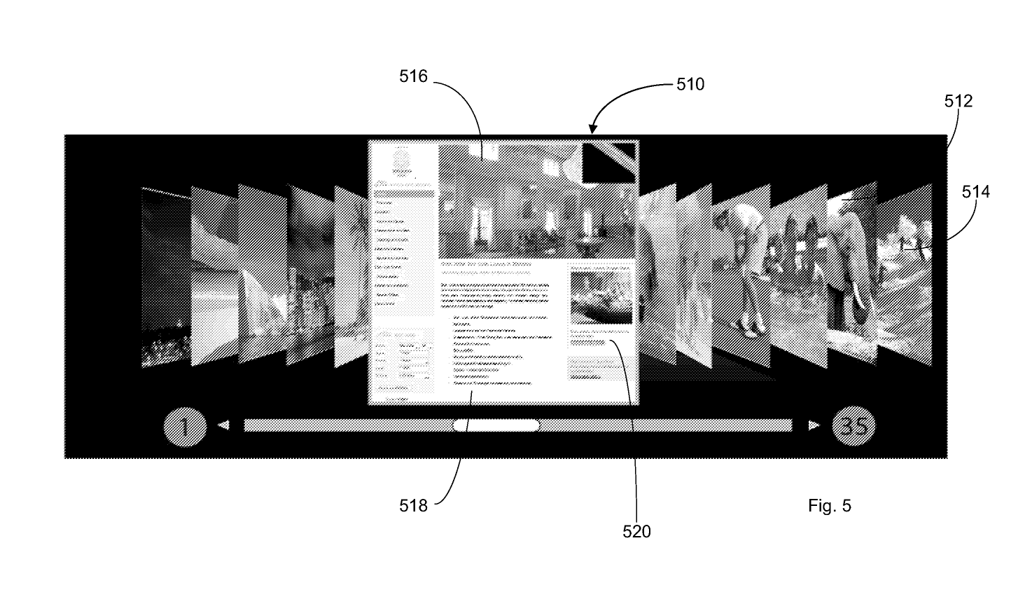

FIG. 5 illustrates an interface for previewing search results;

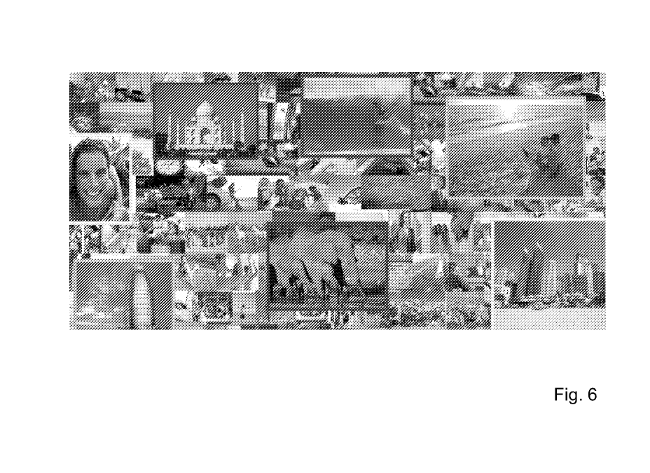

FIG. 6 illustrates an embodiment of a photomontage for presenting search results;

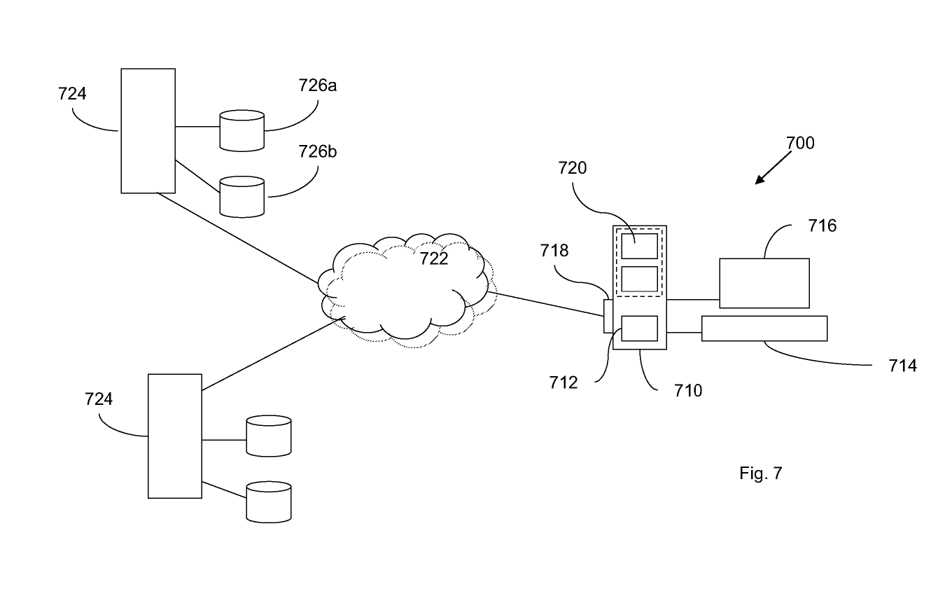

FIG. 7 is a schematic diagram of hardware that may be used to implement the claimed methods.

The embodiment described below relates to a travel search website. However, it will be appreciated that the techniques described below may be used for a wide range of search topics and the description is not intended to be limiting. Further, the different features of the system described may be implemented independently unless otherwise stated.

FIG. 1 illustrates one embodiment of a search screen that may be presented to a user. The search screen of the embodiment illustrated includes a results pane 110, which summarises the results of the search performed so far as described in more detail below. The user is also presented with a plurality of search criterion boxes 112, which are provided to enable a user to select searching parameters or search criteria to add to the search.

Each search criterion box 112 includes a heading portion 114, which summarises the type of search criteria found within the box 112, for example “Activities”, “How many are going?” and “When and how hot?”. Within each search criterion box 112, the user is then presented with a plurality of search criteria 116 or parameters relevant to the heading 114. For example, the box with the “Activities” heading 114 may include search criteria such as “watersports”, “trekking”, “safari” and “golf”. Each of the search criteria 116 in the present embodiment is represented graphically by an image or an icon that is relevant to that search criterion. For example the “watersports” option may be represented using a sailing boat and the “safari” option may be represented using a safari animal. The user selects a particular search criterion to be included in the search by clicking on the relevant picture and dragging it into the results pane 110. Alternatively, the user may double-click on the relevant picture or select a tick-box provided for the picture (not shown).

The results pane 110 shows the results of the user's search based on one or more selected search criteria 116. The search criteria selected by the user are summarised in a list in the results pane 118 and the user is also given the option to delete any search criterion from the search using a delete icon 120. The results pane 110 also includes an indication of the total number of results 122 arising from the search and a “display results” button 124 enables the user to view the results obtained from the search. Preferably, the user will continue to select search criteria to narrow and refine the search to provide fewer than 20 results, preferably 5-10 results, before viewing the search results. An image 126 is displayed in the results pane 110, wherein the image 126 is relevant to the search criteria selected by the user 118. For example, a search including the options “sun”, “family” “Europe” may be represented by an image 126 of a family beach holiday in Spain.

Once the user has selected a single search criterion, the further options displayed to the user change based on the user's first selection. In particular, when the user selects an option from one category, the search criteria displayed change to provide more detailed options within that category. For example, if a user selects “Europe” from the destination search criterion box, the search criteria displayed within that box will change to specific countries and regions within Europe, e/g/ “UK”, “France”, “Eastern Europe”, “Mediterranean”. Once the initial image or images have been selected, the interface may change to allow selection from a list of text options or the input of text to specify the search more narrowly. For example, once “France” is selected as a country, cities and regions of France may be listed for selection as text and/or a text box may be provided to allow the user to input the desired location directly.

The interface may also provide the user with a text box into which the user may enter text, such as keywords, to add to the search. This is particularly useful if there is a specific attribute that is of high importance to one user, but that is not displayed in the first layer of search criteria, for example “disabled access” or “vegetarian”. Natural language processing is provided on any text.

The interface also enables negative searching so that a user can specify that the search results should not have a particular attribute. For example, the user can specify that a hotel or resort should not be listed as child-friendly, to avoid locations with lots of children.

The user can also apply weightings to search options to indicate the relative importance of those options. For some search options, this is provided as a binary option, for example the user selects a tick box if a search option is a “must-have”. For some search options the user can select multiple weights to apply to the option, for example using a slider bar to indicate the relative importance of a particular option.

Any timings entered into the interface can also include an indication of the sensitivity of the timing. For example, if the user indicates that they wish to depart on 1 Aug. 2009, they can also indicate whether this is a fixed deadline or whether they would be happy to consider trips within a week or a month of that date.

While unregistered users may use the site to search and obtain information, a user must register to save searches that have been performed and to save other settings and preferences. For example, a registered user may set their home country or town to enable the interface to provide information more intelligently with regard to suggested travel options. Users can also save, review and amend previous searches. Further features may also be provided to registered users, for example a user may be notified of any current discounts or special offers that are relevant to searches they have previously saved.

FIG. 2 illustrates an alternative embodiment of a search screen that may be presented to a user. In this screen, each of the search criterion boxes 210 is presented as a separate tab. Users may progress through the tabs selecting search criteria 212 from within the various categories, in this embodiment by selecting tick boxes associated with the relevant search criteria 212. A summary of the search criteria selected 216 is provided with the tabs 210 and the results total 218 is displayed to the user at the bottom of each screen together with a button 220 to enable the user to view the search results.

A further embodiment of a search interface is illustrated in FIG. 3. In this embodiment, a plurality of images is displayed to a user in a selection window 310. The images preferably move across the screen and change over time to give the user a wider range of choices between images. The user then clicks on images to select particular images that correspond that represent desired attributes of the holiday.

To refine the images that are displayed to the user and reduce the user's choice of images, the images can be filtered using a text-based or option-selection based search screen 312. This enables a user to narrow down the images available, for example, by selecting “snow” 314, a user may be shown only skiing holidays and trips to the arctic etc. The search screen 312 may also be used to enable the user to input data that are difficult to input using images, for example the required dates for the trip and the user's available budget.

The total number of results arising from the options selected is displayed to the user 316 and the user is also given the opportunity to view further details of the search results, for example by clicking on the results total 316.

The composite photo or photomontage illustrated in FIG. 3 may also be used to display the search results to the user, for example in the results pane of FIG. 1. That is, instead of displaying a single image combining all of the search criteria selected by the user in FIG. 1, the image 126 may comprises a photomontage made up of a plurality of photos, each illustrating at least one of the search criteria selected by the user.

FIG. 4 illustrates one embodiment of a destination guide that may be presented to a user. The guide may enable a user to search for holiday types, activity types, hotels, events and other information relevant to the selected destination.

In the present embodiment, availability and pricing information is made available to a user for a limited number of search results. This data is available to the web interface via a feed from an aggregator of a travel provider, i.e. a travel availability system. However, the system is more powerful than existing interfaces. If the user has provided an indication of “when” they wish to travel, the system obtains availability information for a limited number of results, for example for the final 10 results when the user has cut down the number of results to this amount. If the user has entered details such as the number of people travelling, the system can also incorporate this information into the availability search. In particular, this can allow the system to provide real prices rather than indicative estimates, for example by taking into account whether any rooms will not be filled to the maximum occupancy level.

FIG. 5 illustrates schematically a further aspect that may be implemented in conjunction with the system described herein. FIG. 5 illustrates one mechanism to enable a user to preview search results before selecting a particular result for more detailed review.

Once the search results have been generated, mini-pages 510, 512, 514 are created from information held about each search result. The mini-pages are not simply smaller versions or thumbnail versions of the relevant results page, although they may contain very similar information, but are formatted based on the data held for the relevant result to enable a user to obtain useful information from the mini-page. Based on the information on this page, the user can then decide whether to pursue the result further by clicking on the mini-page to be taken to the full results page.

In a particular example, a user may wish to select a hotel from a plurality of hotels that have been suggested as the results of a search. The system generates a mini-page for each hotel result 510, 512, 514 and presents these to the user, for example in sequence as shown or as a plurality of small windows arranged in rows and columns.

Each mini-page includes key information for the search result. For example, in the case of a hotel, the page may include a main image for the hotel 516, key facts about the facilities at the hotel 518 and comments or ratings about the hotel from other visitors 520.

The user can look through the mini-pages created for the search results and select a result to review further by clicking on the mini-page or selecting it in some other way. The user is then taken to the full page for that result, which contains further information and may be, for example, the website for the relevant hotel.

The results generated by the user's search may be presented as described above as a montage of images or icons. One example of a photomontage is illustrated in FIG. 6. This montage may be displayed on the user interface as described above to illustrate the search results to the user. The search may also be saved in conjunction with the user's profile. However, the montage may also be used independently to illustrate the search to other users. For example, a user may send a link to the search to a second user, for example a friend or fellow traveller, to enable the second user to review the search results. The link may take the form of an image, such as a logo or the montage itself and may be sent directly, for example using an email, a message on a social networking website, or an instant message, or it may be made available to a plurality of users. To make the link available to a group of contacts, without specifically transmitting it to each contact, a user may post the link onto a profile page associated with the user, for example onto the user's profile page on a social networking site or via the user's account on the site on which the search was performed. The link appears as a montage of images as illustrated in FIG. 6.

The search results that generate the montage are encoded into a URL. When a user or a web page accesses the URL, the system generates a montage based on the search terms encoded in the URL. That is, the search is re-performed based on the URL and a montage is generated for display to the user or via the accessing web-page. The montage that results from the search is not exactly the same as the montage that was generated from the original search, since multiple images may result from a particular search term. However, the montage will provide the same overall impression of the search results.

In an alternative embodiment, as described above, the original search results in the generation of a particular montage at a server. This montage may be saved, for example as a single image, in the server and a URL link provided to access the saved image. When a user or web page accesses this URL, the server retrieves the saved image and forwards this to the requesting user or server.

In either embodiment, any user can access the original website on which the search was performed via the displayed montage. A second user may click on the montage to take the user to the search results page on the website. The second user may then change parameters of the search and generate a new montage. The new montage may be transmitted back to the first user and/or stored in association with the second user.

To enable users to search for an item, the system must first be populated with items on which the search can be performed. In the case of a travel website, as described here, these items may include identifiers of destinations, hotels, attractions, events, flights and other elements that make up a trip.

The items are stored in conjunction with associated attributes. For example, the item “hotel” may have multiple attributes that include facilities at the hotel, the location of the hotel, its price-bracket and tags applied by users, for example, “restaurant”, “gym”, “beachfront”, “airport”, “budget”, “expensive”, “romantic” and “family-friendly”. Some items may have more closely defined attributes for example a flight must include both an origin and a destination airport, a date or date-range, and a time of departure.

These items and attributes are stored in a memory facility on a server, or a cluster of servers in a single or distributed database, for example an SQL database.

In addition, a collection of images is also stored in memory on a server or cluster of servers, which may be the same as or distinct from the server(s) storing the items.

The images are also stored in conjunction with keywords or attributes that are represented by the image. For example, an image of a sun may be associated with the attributes “hot” and “winter sun” that may be used for some destinations and a picture of a “restaurant” may have the associated attribute of “restaurant”.

The images and associated attributes and the items and associated attributes may be imported from external data sources. The databases may also be added to manually, for example attributes may be added to existing items or new images may be added to the database.

The data is input from a plurality of sources and is input into the databases in a first data download process and then according to a regular update cycle. Data may already be structured, but any unstructured data is parsed and processed to produce the structured data described above. This data processing is preferably implemented off-line and the data is fully prepared before being uploaded into the databases used by the search system. Extract Transform Load (ETL) tools can be used to process the large amounts of data necessary for the present system. In one embodiment, the data is processed into a Resource Description Framework (RDF) metadata model.

The interface and data storage system is designed to enable multiple users to contribute to a particular search. In one embodiment, a first user generates a first search that is saved in a profile associated with the first user. The search can be notified to other users, for example by email or via their own profiles on the web interface. The first user can specify other users to whom their initial search can be sent, for example to “friends” of the first user within the web interface.

A second user can review the search results generated by the first user and modify the search options selected by the first user, for example to define a further search option or parameter. These modifications may be applied directly to the search results to generate modified search results, which are then notified or displayed back to the first user. The first user can accept the modified search to add the modification into their original search results or reject the changes made by the second user to keep the original search results.

In a similar embodiment, a group of users may contribute to a search. The users may all access the interface at the same time in a “live” format, or the search may be built up over time as the different users contribute to the search. The search options and results are preferably saved with an identifier of the group, which also identifies the users who have contributed to the search, and the selected options and results are displayed to the whole group. Members of the group can invite other users to join the group.

In one embodiment, aspects of the search system can be made available to users via a third party website. That is, users can access the searching facilities and results information that would normally be available through the web interface described above using a frame or applet embedded in another website.

In one particular embodiment, the functionality described above may be provided as an application that can be implemented within another website, such as a social networking website. Results from a search, for example in the form of a montage of images as described above, may be displayed via a user's profile page on the social networking website. The user may also perform a search as described above via the application within the social networking site. Users clicking on an icon associated with the application or on the results montage launch the search application, or may be taken to the main website described above to perform a search.

The results generated within the social networking site may be displayed on the user's profile page and may be transmitted by the user to other users, for example to “friends” to whom the original user is linked within the social network. Other users may post comments on the results.

Search results may also be associated with a particular group on the social networking site. Any member of the group may generate search results for the group which are then displayed within the group. Other group members can then access the search results that have been generated and change parameters to edit the search. The site may store and display a history of previous searches for the group to enable group members to revert to earlier searches. In the particular embodiment of a travel website, the group search functionality may enable a group of friends to plan a trip together.

It will be clear to one skilled in the art that, although the embodiment has been described in relation to a travel website, the same system could be applied to other types of searches. For example, aspects of the system described above could be used to search other subject matter, in particular where users wish to search items based on a number of attributes.

One example is a search in relation to a car. A user may know certain attributes of their desired car, such as its make and model, year of manufacture and engine size. These attributes can be built into a search in a corresponding way to that described above for travel. Another example is that of a job search. Attributes may include the area of work, whether the job is part-time or full-time and whether the job is temporary or permanent.

Other examples of suitable topics for searches that could be performed using the techniques described above include consumer goods, such as consumer electronics e.g. laptops or white goods e.g. washing machines or financial products such as savings accounts or insurance.

As described above, the system will usually be accessed via a web interface, either through a primary website or via a frame or application on a third party website. The web interface will most usually be displayed on a personal computer. However, it will be appreciated that other implementations may also be provided. For example, the web interface may also be designed to operate on a mobile telephone or personal digital assistant (PDA). Further, the interface may also be implemented on a terminal that may be provided, for example within an airport, the offices of a travel agency or another shop such as a coffee shop. Digital or cable television may provide another interface on which the system may be implemented.

In the system described above, the search is accessed via a graphical interface. However, it will be appreciated that alternative interfaces may be provided, particularly if the system is accessed using a different type of terminal. For example, on a PDA or mobile telephone, search criteria may be input verbally or via text, such as using SMS messages. These input means may also be used to modify searches that have already been set up on a web interface. In one embodiment, a user may register their mobile telephone number, or another identifier, with their profile via the web interface. Search criteria that are subsequently sent by text message with the accompanying identifier are then incorporated into the existing search set up by the user.

A particular embodiment of a terminal 700 via which a user can access the system can be implemented using a processing system, an example of which is shown in FIG. 7. In particular, the processing system 710 generally includes at least one processor 720, or processing unit or plurality of processors, memory 712, at least one input device 714 and at least one output device 716, coupled together via a bus or group of buses (not shown). In certain embodiments, input device 714 and output device 716 could be the same device. An interface 718 can also be provided for coupling the processing system 710 to one or more peripheral devices, for example interface 718 could be a PCI card or PC card. The interface 718 may also comprise a modem or network adaptor, for example an Ethernet card. The memory 712 can be any form of memory device, for example, volatile or non-volatile memory, solid state storage devices, magnetic devices, etc. The processor 720 could include more than one distinct processing device, for example to handle different functions within the processing system 710.

Input device 714 receives input data from a user and can include, for example, a keyboard, a pointer device such as a pen-like device or a mouse, audio receiving device for voice controlled activation such as a microphone, data receiver or antenna such as a modem or wireless data adaptor, data acquisition card, etc. Input data could come from different sources, for example keyboard instructions in conjunction with data received via a network. Output device 716 produces or generates output data and can include, for example, a display device or monitor in which case output data is visual, a printer in which case output data is printed, a port, for example a USB port, a peripheral component adaptor, a data transmitter or antenna such as a modem or network adaptor, etc. A user could view data output, or an interpretation of the data output, on, for example, a monitor or using a printer.

In use, the processing system 710 is adapted to allow data or information to be stored in and/or retrieved from, via wired or wireless communication means, the local memory 712 or remote databases via a network. The interface 718 may allow wired and/or wireless communication between the processing unit 710 and peripheral components that may serve a specialised purpose. The processor 710 receives instructions as input data via input device 714 and can display processed results or other output to a user by utilising output device 716. More than one input device 714 and/or output device 716 can be provided. Input data may be received from and output data may be sent to a remote server 724 or a cluster of servers via a network 722 which may include the Internet, connected to the interface 718. It should be appreciated that the processing system 710 may be any form of terminal, server, specialised hardware, or the like and is not limited to the embodiment shown.

Processing system 710 is adapted to communicate with other terminals or servers 724, for example a database server which is connected to a plurality of databases 726a, 726b, by sending and receiving data via a network 722, thereby facilitating communication of data. The remote server 724 may comprise a single server or a cluster of servers, which may be geographically remote from each other, for example being implemented as a “cloud”. The server(s) 724 may be standalone devices implementing the system described herein or the described system may be implemented on a portion of the server(s) 724, which may also provide other functionality, for example by serving other web-based applications. For resiliency and redundancy, the servers 724 are preferably separated geographically and topographically.

The server(s) 724 are connected to at least one database and preferably a plurality of databases 726a, 726b. The databases 726a, 726b may also be provided in cluster or “cloud” arrangement and are preferably also geographically and topographically separated over the network 722.

It will be appreciated that the systems and methods described herein find particular application when implemented in conjunction with a semantic web system or with data organised in a semantic web format. The semantic web provides a structure within which not only the data itself is stored, but metadata relating to the data is stored in conjunction with the data. This makes the data more accessible and more useful since it is easier for a user to find relevant data and the system itself can suggest or highlight data that it knows to be related to data in which the user is interested. The present system leverages the tools of the semantic web to provide a more intuitive search interface that enables a user to find relevant results more quickly and easily than existing search systems.

As mentioned above, the system may use a semantic web structure by formatting data, or taking in data already formatted, in the Resource Description Framework (RDF) format, which provides a structure in which data and the relationships between items of data may be more fully described. Other data formats that may be used in conjunction with the present system include Extensible Markup Language (XML) and Web Ontology Language (OWL)

Data items within the semantic web may be considered to be objects, each object having associated attributes, properties, classes and relationships to other objects. The semantic web and the definitions of and relationships between data that it defines can enable a computer to perform some of the processing that currently has to be performed by the human searcher, for example by suggesting to a user which search criteria to select next as described herein, that is it makes the data more understandable to a computer.

The present system can use semantic attributes of items of data by aliasing the semantic attributes of the data to images, hence creating a semantic search interface having some or all of the features described above.

1. A method of searching a plurality of items using at least one of a plurality of search criteria, the method comprising:
providing for display to a user a plurality of images, each image associated with at least one search criterion;
receiving input from the user to select at least one image from the plurality of images;
determining the or each search criterion associated with the or each selected image;
searching the plurality of items to retrieve items based on the or each search criterion;
storing in memory a first intermediate list of identifiers of the retrieved items;
determining a revised set of search criteria based on the items identified in the first intermediate list; and
providing for display a revised set of images associated with the revised set of search criteria;
receiving further input from the user to select a second image from the revised set of images and determining a second search criterion based on the second image; and
searching the retrieved items identified in the first intermediate list based on the second search criterion.

2. The method of claim 1 in which each item has a plurality of attributes and wherein each search criterion is associated with at least one attribute.

3. The method of claim 1 in which the plurality of items includes at least 100 items, each item having at least three attributes and wherein the search criteria are predefined and each search criterion is associated with at least one attribute, and wherein each image provided for display to a user is associated with a plurality of search criteria, the method comprising:
storing in a database a plurality of images and storing an association between each image and at least one search criterion;
storing in a database a plurality of search criteria and storing an association between each search criterion and at least one of the plurality of attributes;
storing in a database the plurality of items and storing an association between each item and each of a plurality of attributes;
determining at least one selected attribute associated with the or each search criterion; and
outputting a total number of items identified in the first intermediate list;
storing in memory a second intermediate list of identifiers of the items retrieved from the first intermediate list; and
outputting a total number of items identified in the second intermediate list;
wherein searching the plurality of items to retrieve items based on the or each search criterion comprises searching the plurality of items to retrieve items having the at least one selected attribute;
and wherein determining a revised set of search criteria comprises determining a revised set of search criteria in which each search criterion in the revised set has at least one attribute associated with the items identified in the first intermediate list;
and wherein determining a second search criterion comprises determining a second search criterion associated with the second image and a second selected attribute associated with the second search criterion
and wherein searching the retrieved items identified in the first intermediate list based on the second search criterion comprises searching the retrieved items identified in the first intermediate list to retrieve items having the second selected attribute.

4. A method according to claim 3 further comprising:
receiving further input from the user to select a third image from the plurality of images and determining a third search criterion associated with the third image and a third selected attribute associated with the third search criterion;
searching the retrieved items identified in the second intermediate list to retrieve items having the third selected attribute;
storing in memory a third intermediate list of identifiers of the retrieved items; and
outputting a total number of items identified in the third intermediate list.

5-9. (canceled)

10. A method according to claim 2 wherein the number of images selected provides at least five selected attributes and the method includes searching the items to retrieve items having the five selected attributes.

11. A method according to claim 2 further comprising receiving input from a user to provide selected attributes until the total number of items identified is less than 100 items, preferably less than 20 items.

12. A method according to claim 2 further comprising providing for display the list of identifiers of retrieved items having the selected attributes, wherein the identifiers preferably include an image associated with the retrieved items.

13. (canceled)

14. A method according to claim 1 wherein at least one of the revised set of images corresponds to at least one search criterion in a lower level of a hierarchy of search criteria.

15. (canceled)

16. A method according to claim 1 wherein the method is implemented in the processor of a server, wherein the intermediate list of identifiers of the retrieved items is stored in the memory of the server and wherein the images are provided for display and the total number of retrieved items are output via an output interface of the server.

17. (canceled)

18. A server for searching a plurality of items using at least one of a plurality of search criteria, the server comprising:
means for providing for display to a user a plurality of images each image associated with at least one search criterion;
means for receiving input from the user to select at least one image from the plurality of images;
means for determining the or each search criterion associated with the or each selected image;
means for searching the plurality of items to retrieve items based on the or each search criterion;
means for storing in memory a first intermediate list of identifiers of the retrieved items;
means for determining a revised set of search criteria, based on the items identified in the first intermediate list; and
means for providing for display a revised set of images associated with the revised set of search criteria;
means for receiving further input from the user to select a second image from the revised set of images and determining a second search criterion based on the second image; and,
means for searching the retrieved items identified in the first intermediate list based on the second search criterion.

19-20. (canceled)

21. A server for searching a plurality of using at least one of a plurality of search criteria, the server comprising:
an output interface for providing for display to a user a plurality of images associated with a plurality of search criteria;
an input interface for receiving input from the user to select at least one image from the plurality of images;
a processor operable to implement the steps of:
determining the or each search criterion associated with the or each selected image;
searching the plurality of items to retrieve items based on the or each search criterion;
storing in memory a first intermediate list of identifiers of the retrieved items;
determining a revised set of search criteria based on the items identified in the first intermediate list; and
providing for display a revised set of images associated with the revised set of search criteria;
receiving further input from the user to select a second image from the plurality of images and determining a second search criterion based on the second image searching the retrieved items identified in the first intermediate list based on the second search criterion
storing in a memory a second intermediate list of identifiers of the retrieved items;
an output interface for outputting a total number of items identified in the second intermediate list.

22. The server of claim 21 in which each item has a plurality of attributes and wherein each search criterion is associated with at least one attribute.

23. The server of claim 21 in which the plurality of items comprise at least one hundred items each item having at least three attributes, wherein each search criterion is predefined and associated with at least one attribute, the server comprising:
a memory comprising a database for storing a plurality of images and an association between each image and at least one search criterion;
a memory comprising a database for storing a plurality of search criteria and an association between each search criterion and at least one of a plurality of attributes;
a memory comprising a database for storing the plurality of items and an association between each item and each of a plurality of attributes; and the processor operable to implement the steps of:
determining at least one selected attribute associated with the or each search criterion;
outputting a total number of items identified in the first intermediate list;
determining a list of attributes associated with the items identified in the first intermediate list;
wherein each search criterion in the revised set has at least one attribute associated with the items identified in the first intermediate list; and wherein determining a second search criterion comprises determining a second search criterion associated with the second image and a second selected attribute associated with the second search criterion;
and wherein searching the retrieved items identified in the first intermediate list comprises searching the retrieved items identified in the first intermediate list to retrieve items having the second selected attribute.

24. A method of searching a plurality of at least one hundred items using at least one of a plurality of predefined search criteria, each item having at least three attributes, wherein each search criterion is associated with at least one attribute, the method comprising:
storing the plurality of predefined search criteria for the search in memory;
providing for display to a user a first selected set of the predefined search criteria;
receiving input from the user to select a first search criterion from the selected set of predefined search criteria;
receiving input from a user to select a second search criterion from the selected set of predefined search criteria;
calculating a total number of items having the attribute associated with the first search criterion and the attribute associated with the second search criterion;
outputting the calculated total number of items for display to the user;
calculating the total number of items remaining if each of the remaining search criteria was selected in conjunction with the first search criterion and the second search criterion;
selecting a modified set of predefined search criteria based on the total number of items remaining;
outputting the modified set of predefined search criteria for display to the user.

25-45. (canceled)

46. A method of searching a plurality of items claim 1 wherein the first search criterion is received from a first user and the second search criterion is received from a second user, wherein the first user is geographically remote from the second user, and parsing the first search criterion and the second search criterion to determine compatibility between the first search criterion and the second search criterion.

47. (canceled)

48. A method according to claim 46 wherein, if the first search criterion and the second search criterion are not compatible, the method further comprises requesting the second user to confirm that the first search criterion should be over-written by the second search criterion.

49. A method according to claim 46 further comprising notifying the first user of at least one of the input received from the second user and the search results produced by the second search criterion.

50. A method according to any of claim 46 further comprising storing the search results as a search project accessible by both the first user and the second user.

51. A method according to claim 1 further comprising:
providing an interface via a third party website to display the plurality of search criteria via the third party website;
receiving from a user at the third party website a selection of at least one criterion by the user;
displaying to the user via the third party website the first and second intermediate list of identifiers;
displaying to the user via the third party website a graphical representation of the items identified in the second intermediate list.

52-54. (canceled)

55. A computer program, computer program product or computer readable medium comprising instructions for implementing a method according to claim 1.

56.-58. (canceled)
